(19) United States
(12) Patent Application Publication
(10) Pub. No.: US 2026/0333197 A1
(43) Pub. Date: Oct. 22, 2026

(54) SYSTEM INFORMATION UPDATES USING PARTIAL SYSTEM INFORMATION BLOCKS

(71) Applicant: Lenovo (United States) Inc., Morrisville, NC (US)

(72) Inventors: Prateek Basu Mallick, Dreieich (DE); Joachim Löhr, Wiesbaden (DE)

(73) Assignee: Lenovo (United States) Inc., Morrisville, NC (US)

(21) Appl. No.: 19/380,776

(22) Filed: Nov. 5, 2025

(51) Int. Cl. H04W 48/10; H04W 74/0833

(52) U.S. Cl. CPC H04W 48/10; H04W 74/0833

(57) ABSTRACT

Various aspects of the present disclosure relate to system information (SI) updates using partial SI blocks (SIBs). A network entity (NE) transmits, to a user equipment (UE), a SIB including a first version identifier and a set of information elements (IEs). The UE stores the SIB. The NE transmits an SI change indication based on modified values for at least one IE of the subset of IEs. The NE transmits, to the UE, a partial SIB associated with the subset of IEs. The partial SIB includes the subset of IEs, the modified values, the first version identifier, and a second version identifier of the partial SIB. The first version identifier is indicative of a reference version of the SIB and the second version identifier is indicative of a modified version of the subset of IEs relative to the reference version. The UE merges the partial SIB with the stored SIB.

### TECHNICAL FIELD

The present disclosure relates to wireless communications, and more specifically to handling (e.g., processing, modifying, updating, comparing, encoding, decoding, transmitting, receiving) system information (SI).

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive SI including a master information block (MIB) and at least one system information block (SIB), where the at least one SIB includes a first version identifier of the SIB and a set of information elements (IEs), receive an indication of a change in the SI, and receive a partial SIB, where the partial SIB includes a subset of IEs of the set of IEs, modified values for at least one IE of the subset of IEs, the first version identifier, and a second version identifier of the partial SIB, where the first version identifier is indicative of a reference version of the at least one SIB and the second version identifier is indicative of a modified version of the subset of IEs relative to the reference version.

A processor for wireless communication is described. The processor may be configured to, capable of, or operable to perform one or more operations as described herein. For example, the processor may be configured to, capable of, or operable to receive SI including a MIB and at least one SIB, where the at least one SIB includes a first version identifier of the SIB and a set of IEs, receive an indication of a change in the SI, and receive a partial SIB, where the partial SIB includes a subset of IEs of the set of IEs, modified values for at least one IE of the subset of IEs, the first version identifier, and a second version identifier of the partial SIB, where the first version identifier is indicative of a reference version of the at least one SIB and the second version identifier is indicative of a modified version of the subset of IEs relative to the reference version.

A method performed or performable by a UE for wireless communication is described. The method may include receiving and storing SI including a MIB and at least one SIB, where the at least one SIB includes a first version identifier and a set of IEs, receiving an indication of a change in the SI, and receiving a partial SIB, where the partial SIB includes a subset of IEs of the set of IEs, modified values for at least one IE of the subset of IEs, the first version identifier, and a second version identifier of the partial SIB, where the first version identifier is indicative of a reference version of the at least one SIB and the second version identifier is indicative of a modified version of the subset of IEs relative to the reference version.

In some implementations of the UE, the processor, and the method described herein, the UE may be configured to, capable of, or operable to compare a third version identifier with the first version identifier, where the third version identifier indicates a version of the at least one SIB stored by the UE, and one of: if the third version identifier matches the first version identifier, apply the modified values to update the at least one SIB and replace the first version identifier with the second version identifier, or if the third version identifier does not match the first version identifier, reacquire a complete SIB via broadcast SI acquisition. In some implementations of the UE, the processor, and the method described herein, the UE may be configured to, capable of, or operable to transmit a random access channel (RACH) message indicating an SI request, the SI request including at least one of a third version identifier, a request type flag, or a bitmap, each bit in the bitmap corresponding to a respective complete SIB.

In some implementations of the UE, the processor, and the method described herein, the UE may be configured to, capable of, or operable to transmit an SI request via physical random access channel (PRACH) resources configured for partial SIB requests or PRACH resources configured for complete SIB requests. In some implementations of the UE, the processor, and the method described herein, the partial SIB is encoded using Abstract Syntax Notation One (ASN.1) with packed encoding rules (PER) and includes a SIB identity that identifies the at least one SIB on which the partial SIB is based. In some implementations of the UE, the processor, and the method described herein, each IE of the subset of IEs in the partial SIB is identified using a respective CHOICE structure including a corresponding need code field. In some implementations of the UE, the processor, and the method described herein, each CHOICE structure identifying the at least one IE includes a respective modified value of the modified values. In some implementations of the UE, the processor, and the method described herein, the partial SIB includes a bitmap indicating bit positions of the subset of IEs within the at least one SIB, each bit in the bitmap corresponding to a respective IE of the subset of IEs, and a value of each bit in the bitmap indicates whether a modified value for the respective IE is included in the partial SIB.

An NE for wireless communication is described. The NE may be configured to, capable of, or operable to perform one or more operations as described herein. For example, the NE may be configured to, capable of, or operable to transmit SI including a MIB and at least one SIB, where the at least one SIB includes a first version identifier of the SIB and a set of IEs, transmit an indication of a change in the SI based on modified values for at least one IE of a subset of IEs of the set of IEs, and transmit a partial SIB associated with the subset of IEs, where the partial SIB includes the subset of IEs, the modified values, the first version identifier, and a second version identifier of the partial SIB, where the first version identifier is indicative of a reference version of the at least one SIB and the second version identifier is indicative of a modified version of the subset of IEs relative to the reference version.

A processor for wireless communication is described. The processor may be configured to, capable of, or operable to perform one or more operations as described herein. For example, the processor may be configured to, capable of, or operable to transmit SI including a MIB and at least one SIB, where the at least one SIB includes a first version identifier of the SIB and a set of IEs, transmit an indication of a change in the SI based on modified values for at least one IE of a subset of IEs of the set of IEs, and transmit a partial SIB associated with the subset of IEs, where the partial SIB includes the subset of IEs, the modified values, the first version identifier, and a second version identifier of the partial SIB, where the first version identifier is indicative of a reference version of the at least one SIB and the second version identifier is indicative of a modified version of the subset of IEs relative to the reference version.

A method performed or performable by an NE for wireless communication is described. The method may include transmitting SI including a MIB and at least one SIB, where the at least one SIB includes a first version identifier of the SIB and a set of IEs, transmitting an indication of a change in the SI based on modified values for at least one IE of a subset of IEs of the set of IEs, and transmitting a partial SIB associated with the subset of IEs, where the partial SIB includes the subset of IEs, the modified values, the first version identifier, and a second version identifier of the partial SIB, where the first version identifier is indicative of a reference version of the at least one SIB and the second version identifier is indicative of a modified version of the subset of IEs relative to the reference version.

In some implementations of the NE, the processor, and the method described herein, the NE may be configured to, capable of, or operable to receive an SI request from a UE, where the SI request includes a third version identifier. In some implementations of the NE, the processor, and the method described herein, the SI request is received via a RACH message, where the NE may be configured to, capable of, or operable to determine whether the SI request is for the partial SIB or for a complete SIB based on the third version identifier, a request type flag included in the SI request, or a bitmap included in the SI request, where each bit in the bitmap corresponds to a respective complete SIB. In some implementations of the NE, the processor, and the method described herein, the third version identifier indicates a version of the at least one SIB stored by the UE, where the modified values are determined based on the third version identifier. In some implementations of the NE, the processor, and the method described herein, the SI request is received via PRACH resources configured for partial SIB requests or PRACH resources configured for complete SIB requests, where the NE may be configured to, capable of, or operable to determine whether the SI request is for the partial SIB or for a complete SIB based on the PRACH resources or a corresponding PRACH preamble.

In some implementations of the NE, the processor, and the method described herein, the partial SIB is encoded using ASN.1 with PER and includes a SIB identity that identifies the at least one SIB on which the partial SIB is based. In some implementations of the NE, the processor, and the method described herein, each IE of the subset of IEs in the partial SIB is identified using a respective CHOICE structure including a corresponding need code field. In some implementations of the NE, the processor, and the method described herein, each CHOICE structure identifying the at least one IE includes a respective modified value of the modified values. In some implementations of the NE, the processor, and the method described herein, the partial SIB includes a bitmap indicating bit positions of the subset of IEs within the at least one SIB, each bit in the bitmap corresponding to a respective IE of the subset of IEs, and a value of each bit in the bitmap indicates whether a modified value for the respective IE is included in the partial SIB. In some implementations of the NE, the processor, and the method described herein, the partial SIB is transmitted via a broadcast control channel or as dedicated SI delivery.

### BRIEF DESCRIPTION OF THE DRAWINGS

FIG. 1 illustrates an example of a wireless communications system in accordance with aspects of the present disclosure.

FIGS. 2 through 4 illustrate example signaling diagrams, in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

### DETAILED DESCRIPTION

A wireless communications system includes one or more devices (e.g., UEs and NEs) that exchange signaling. In 5G New Radio (NR), SI provides essential parameters that enable UEs to discover, evaluate, and access cells, as well as determine optional capabilities and services. The SI framework incorporates concepts from Long Term Evolution (LTE), such as MIBs, SIBs, and paging-based change indications, while implementing a more structured content organization and transport mechanism. This structured approach separates content from transport mechanisms, enabling more flexible delivery options. Additionally, 5G NR introduces an on-demand SI mechanism to avoid continuous broadcasting of all SI, allowing UEs to request specific SIBs only when needed rather than receiving all SI through periodic broadcasts.

Radio resource control (RRC) specifications define the SI delivery framework, including logical messages, procedures, and timers that govern how UEs acquire and maintain SI. SI is delivered via two message families on the broadcast control channel (BCCH), which may be mapped to either a physical broadcast channel (PBCH) or downlink shared channel (DL-SCH) depending on the information type and delivery requirements. For example, a compact MIB is transmitted on PBCH, providing fundamental parameters necessary for initial cell access, while one or more SIBs are transmitted on DL-SCH, where SIB1 is designated for cell-specific information including cell selection criteria and access parameters, and other SIBs (one or more of which may be referred to herein as “SIBx”) are grouped into “SystemInformation messages” based on periodicity and purpose. Abstract Syntax Notation One (ASN.1) message containers are explicitly defined to ensure consistent encoding and decoding across different network implementations, with MIB carried in BCCH-BCH-Message for direct PBCH transmission and both SIB1 and multi-SIB SystemInformation messages carried in BCCH-DL-SCH-Message.

A UE initiates SI acquisition by decoding the PBCH within a detected synchronization signal (SS)/PBCH block (SSB) to obtain the MIB. The MIB includes IEs containing a set of SI parameters, such as subcarrier spacing for SSB/PBCH and control resource positions for initial PDSCH, that are sufficient to enable subsequent decoding of SIB1 on PDSCH. This hierarchical approach ensures that UEs can progressively acquire more detailed SI as needed. For example, SI acquisition may proceed in defined phases: first acquiring the MIB and SIB1 to establish basic cell parameters and access rules, followed by acquisition of additional SI messages containing supplementary configuration information. After decoding SIB1, the UE obtains cell access rules, including barring information and access class restrictions, as well as scheduling and request information for remaining SI.

SI delivery and broadcasting represents a significant source of network energy consumption. Continuous broadcasting of SI enables UE initial access, cell selection, and ongoing operations, but is associated with substantial power consumption. As networks evolve towards 6G with increased deployment density and wider bandwidths, improving energy efficiency and reducing power consumption becomes increasingly important. However, current SI delivery mechanisms suffer from significant inefficiencies that result in relatively high energy consumption and signaling overhead.

SI updates in deployed networks occur infrequently, typically triggered by network configuration changes, mobility management updates, or service modifications, and generally involve modifications to a subset of SI parameters rather than the entire content of a SIB. For example, in a hierarchical SIB structure containing multiple IEs with nested parameters, an update may affect only a single parameter within a larger IE tree while leaving other parameters unchanged. However, current 5G NR implementations require transmission of complete SIBs even when only a small fraction of the parameters have changed, resulting in wasted resources and unnecessary energy consumption. This inefficiency becomes particularly problematic in dense network deployments where frequent minor updates could be handled more efficiently through selective parameter transmission (which may be referred to herein as “delta signaling”).

In current 5G NR implementations, SIBs are delivered as complete IE containers, requiring full replacement of stored SI upon any modification. Change signaling, implemented through paging systemInfoModification followed by SIB1 reading, indicates which SI message changed but provides no granular information about specific modified fields within the SI message. This coarse-grained approach results in transmission of unchanged parameters along with modified ones, increasing signaling overhead and energy consumption. Moreover, RRC procedures assume whole-SIB semantics, with UEs maintaining cached copies of SIB1 and other SIBs that are completely replaced upon reacquisition rather than selectively updated. The paging mechanism provides only a general “SI changed” indication, after which UEs must reacquire complete SystemInformation messages or SIBs through broadcast channels or on-demand requests. Even for RRC Connected state updates via dedicated SystemInformation delivery, complete SIB instances are transmitted rather than field-level delta updates.

Additionally, current RRC message encoding using ASN.1 with unaligned Packed Encoding Rules (PER) presents fundamental obstacles to implementing efficient delta signaling mechanisms. While PER encoding optimizes message size by eliminating field names and relying on positional encoding based on the ASN.1 schema definition, it is incapable of transmitting parameter field names over the air and lacks built-in support for delta or differential (“diff”) updates. For example, a decoder interprets a received bitstream strictly according to ASN.1 definitions and field ordering as specified in RRC specifications, following a predetermined sequence that assumes complete message structures. This encoding approach prevents reception of isolated IEs for selective merger into stored SIBs, as the decoder cannot identify which specific fields are being updated without receiving the complete message structure. The positional nature of PER encoding creates a fundamental incompatibility with delta signaling approaches, as unlike self-describing encoding formats that include field identifiers, PER relies on the receiver's knowledge of the complete ASN.1 schema to interpret each bit position correctly. Consequently, transmitting only a subset of parameters would result in decoding errors, as the receiver would misinterpret the bit positions of subsequent fields, forcing networks to transmit complete SIBs even for minor updates.

Accordingly, the techniques described herein provide for delta signaling for SI updates in wireless communications systems. The described techniques enable transmission of only modified parameters while maintaining compatibility with existing encoding frameworks. By implementing partial SIBs that include version identifiers and selective parameter updates, the described techniques reduce network energy consumption and signaling overhead while ensuring reliable SI delivery and UE synchronization.

According to the present disclosure, when SI updates or other changes in SI parameters occur, a NE can transmit modified values only for the subset of IEs that have changed, rather than updating all IEs of a SIB. The NE generates a partial SIB that includes only the subset of IEs with modified values, along with a base version identifier corresponding to the original SIB and a new version identifier. The NE transmits an indication that SI has been modified and subsequently transmits the partial SIB to UEs in the coverage area. A UE receives the partial SIB and compares the base version identifier with the version identifier of its stored SIB. When the version identifiers match, the UE applies the modified values from the partial SIB to update its stored SIB and replaces the stored version identifier with the new version identifier. In this manner, the UE can merge the partial SIB with the stored SIB rather than replacing the SIB entirely.

The described techniques provide significant advantages over conventional SI delivery mechanisms by addressing the fundamental inefficiencies inherent in current 5G NR implementations. For example, by transmitting only modified parameters (e.g., subsets of IEs) rather than complete SIBs, the techniques described herein improve overall efficiency by reducing signaling overhead and network energy consumption, particularly in scenarios where SI updates affect only a subset of parameters within larger IE structures. The version identifier mechanism ensures reliable synchronization between network entities and UEs, preventing application of outdated delta updates that could result in inconsistent SI states. Additionally, by selectively transmitting modified parameters, frequent SI updates may be performed without increasing signaling overhead, supporting dynamic network optimization and improved resource utilization. Further, the described techniques reduce UE processing requirements by eliminating the need to decode and process unchanged parameters, contributing to improved battery life and overall system efficiency.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

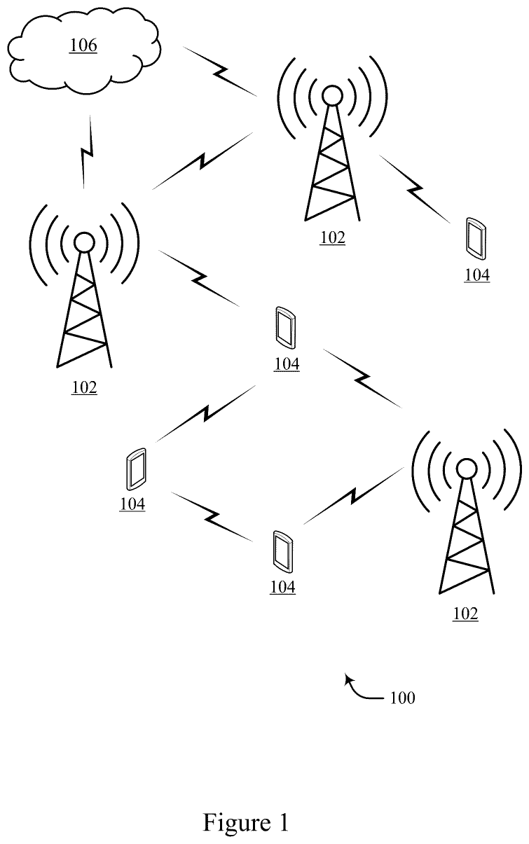

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a NE, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access NE, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the wireless communications system 100, SI provides fundamental parameters and configuration data that enable the UEs 104 to discover, access, and operate within cells served by NEs 102. SI may include parameters for cell selection and reselection, access control information, radio resource configurations, and operational parameters that govern UE behavior within the network. The SI framework may be structured hierarchically, with different types of information blocks carrying different categories of parameters, such as SIBs that provide basic cell parameters and SIBs that contain more detailed configuration information. SIBs may include various types such as SIB1, which contains cell selection information and access parameters, SIB2 for radio resource configuration, SIB3 for cell reselection information, and other SIBs that carry specific configuration data for different network functions and services. An NE 102 may broadcast SI periodically to ensure UEs 104 in the cell can acquire necessary parameters for initial access, mobility procedures, and ongoing operations.

SIB1 is always cell-specific and serves a central role in SI delivery, as it contains cell-specific parameters necessary for UEs 104 to evaluate cell access permissions (e.g., Public Land Mobile Network (PLMN) identities, cell barring status, access control information, and the like) and it defines how other SI is obtained. SIB1 defines the SI scheduling framework by conveying the S1 scheduling map, which indicates which SIBs are bundled into specific SI messages, their transmission periodicities, and any windowing constraints for SI acquisition. Additionally, SIB1 indicates whether one or more SIBs are provided on-demand rather than through periodic broadcast, and when on-demand delivery is configured, SIB1 provides the configuration (e.g., SI-RequestConfig) and related Physical Random Access Channel (PRACH) parameters that enable UEs to request specific SIBs. In Release 19, SIB1 itself may be provided on-demand, with the configuration for requesting SIB1 provided either by neighboring cells or by the serving cell when broadcasting SIB1.

The wireless communications system 100 implements a paging-based SI change indication mechanism to maintain current SI for idle and inactive UEs 104. When SI changes occur, the NE 102 may transmit paging messages to UEs 104 with a systemInfoModification indication, prompting UEs 104 to reacquire affected SIBs in their entirety according to established acquisition procedures. UEs 104 may independently verify SI currency by acquiring SIB1 periodically, such as every 160 milliseconds or once per SI modification boundary.

In some examples, an NE 102 may mark selected SIBs as “notBroadcasting” and provide UEs 104 with procedures for requesting these SIBs when needed, e.g., rather than continuously broadcasting infrequently used SI. For idle and inactive UEs 104, the SI request procedure may involve SI-request random access using SI-RequestConfig parameters from SIB1, where requests may be signaled via RACH using SI-specific preambles, after which the NE 102 schedules the requested SystemInformation on DL-SCH. For connected-mode UEs 104, the NE 102 may permit SI requests through DedicatedSIBRequest messages transmitted on the Dedicated Control Channel (DCCH), with request behavior governed by onDemandSIB-Request flags and prohibit timers to prevent excessive request frequency. Message 1-based requests utilize PRACH resources, including preambles and time-frequency resources, to indicate which SI message is requested, while Message 3-based requests employ RRCSystemInfoRequest messages.

Current SI update procedures in the wireless communications system 100 are relatively inefficient when SI modifications affect only a subset of parameters within a SIB. When the NE 102 updates SI, it transmits a paging message including an “SI changed” indication, after which UEs 104 must reacquire complete SystemInformation messages or SIBs. Even for RRC Connected state updates via dedicated SystemInformation delivery, the NE 102 transmits complete SIB instances rather than field-level delta updates, perpetuating inefficient transmission of unchanged information alongside actual updates. Upon receiving the paging message, a UE 104 reads SIB1 to determine from scheduling information that value tags for specific SIBs have changed, and subsequently reacquires complete SIBs of interest rather than receiving only the modified parameters. This approach results in transmission and reception of unchanged parameters along with modified ones, creating unnecessary signaling overhead and energy consumption.

The limitations of current SI delivery mechanisms become apparent when considering that SI updates typically affect only a few parameters rather than entire SIB contents. In a hierarchical SIB structure resembling a tree with multiple branches, updates may affect only individual leaves while leaving other branches unchanged. However, RRC message encoding based on ASN.1 with unaligned PER does not transmit field names over the air and lacks built-in delta or differential update capabilities. A decoder interprets bitstreams strictly according to ASN.1 definitions and field ordering specified in RRC specifications, preventing UEs 104 from receiving isolated IEs and merging them into stored SIBs. Moreover, unlike self-describing encoding formats, the positional encoding nature of ASN.1 PER relies on predetermined field sequences without runtime visibility of IE names, requiring complete message structures for proper decoding.

According to the techniques described herein, NEs 102 and UEs 104 may implement delta SI signaling techniques that enable transmission of only modified parameters while maintaining compatibility with existing encoding frameworks. For example, upon determining changes in one or more IEs of a SIB, the NE 102 may generate a partial (e.g., delta) SIB containing the one or more IEs with updated values, a base version identifier corresponding to a version identifier of the original SIB, and a new version identifier indicative of a modified version of the one or more IEs (e.g., relative to the one or more IEs included in the original SIB). The partial SIB utilizes CHOICE structures or bitmap-based encoding to provide self-describing capabilities, allowing individual IEs to be transmitted independently and understood by the UE 104 without requiring the complete SIB. Continuing the tree example, each parameter/IE may correspond to an individual leaf (“LeafUpdate”), and the partial SIB may include the subset of IEs as a list (e.g., sequence, set) “updates-IE” of LeafUpdates. Additionally, the partial SIB is transmitted using the same delivery channels and mechanisms as regular SIBs, preserving compatibility with existing infrastructure while enabling efficient parameter-level updates.

The partial SIB may include a SIB identity (e.g., sibType) that identifies the SIB to which the delta updates apply, such that a UE 104 receiving the partial SIB can correctly associate the updates with the appropriate stored SIB. The partial SIB may further include a base version identifier (e.g., baseValueTag) that corresponds to a version identifier of the original SIB (e.g., a valueTag included in the original SIB). Additionally, the partial SIB may contain a new version identifier (e.g., NewValueTag) associated with the partial SIB and indicative of a modified version of the IEs included in the partial SIB. A UE 104 receives the partial SIB and compares the base version identifier with a stored SIB version identifier. If the base version identifier matches the stored SIB version identifier, the UE 104 determines that the partial SIB is applicable and merges the partial SIB with the stored SIB. If the base version identifier does not match the stored SIB version identifier, indicating outdated stored SI, the UE 104 can initiate reacquisition of a complete version of the SIB.

In implementations, a partial SIB is defined for a predetermined subset of IEs from a corresponding SIB. Here, the partial SIB may be understood as a static, predefined structure that includes CHOICE options for specific parameters (e.g., IEs) that may be frequently updated. For example, the NE 102 may define a partial SIB for SIB1 that includes a set of parameters such as cell access information and mobility parameters. The NE 102 may dynamically select which parameters of the set of parameters to update via the partial SIB, enabling runtime selections of updates while maintaining a fixed structural framework. The partial SIB may include one or more need codes that indicate default behavior for handling IEs, such as replacing old values with new values when updates are received and maintaining existing values when updates are not provided.

Additionally, or alternatively, a universal partial SIB may be defined that includes a bitmap corresponding to each IE of the associated SIB. The bitmap indicates which updated IE values are included in the partial SIB payload, providing flexible signaling of arbitrary parameter combinations without requiring predefined parameter groupings. Upon reception of the partial SIB, a UE 104 processes the bitmap to identify which IEs have been updated and are included in the payload. The UE 104 applies the corresponding values to its stored SIB.

The UE 104 may implement different processing approaches depending on the encoding structure of the received partial SIB. For partial SIBs utilizing CHOICE structures, the UE 104 processes each IE update by identifying the specific parameter being modified through the CHOICE identifier and applying the corresponding updated value along with any specified need codes that govern parameter handling behavior. For partial SIBs utilizing bitmap-based encoding, the UE 104 processes the bitmap to identify which IEs have been updated by examining each bit position, then sequentially applies the updated values from the payload to the corresponding parameters in the stored SIB according to the predetermined parameter ordering established in the bitmap structure.

In implementations, the wireless communications system 100 may implement delta configuration signaling for RRC configurations, extending the techniques described herein beyond SI updates to RRC configuration and reconfiguration management. While delta signaling is currently available for RRC reconfigurations, it is based on the currently-used RRC configuration. If ambiguity about the current configuration exists, e.g., if a most-recent RRC reconfiguration has not been received and/or applied by the UE 104, then a further delta signaling can create issues. Additionally, current implementations lack flexibility to re-use a valid RRC configuration that was previously in use (i.e., not in use currently) but is a better alternative for delta signaling. For example, a new RRC configuration to be implemented may match a previously-used RRC configuration more closely than the RRC configuration currently in use, with only minimal parameter changes between the new RRC configuration and the previously-used RRC configuration. Thus, signaling an indication of the previously-used RRC configuration and the changed parameters, rather than signaling an entire new RRC configuration, may improve efficiently and reduce signaling overhead.

Each RRC configuration sent to a UE 104 may be associated with a respective identifier. Upon determining updates or modifications to an RRC configuration, an NE 102 may transmit, to one or more UEs 104, a partial RRC configuration message that includes the updates and the respective identifier corresponding to the RRC configuration to be updated. The RRC configuration to be updated may be currently in use by the UEs 104 or may be a previously-used RRC configuration (e.g., that is not currently in use). The partial RRC configuration message may be separately defined as a separate RRC message type. In some examples, the partial RRC configuration message may indicate a need code that applies to all IEs within the referenced configuration, instructing the UE 104 whether to maintain existing values or release current values for parameters not explicitly included in the partial RRC configuration message. This delta configuration approach enables significant reductions in signaling overhead while maintaining configuration accuracy, particularly when configuring multiple cells with overlapping parameter sets or when updating configurations that share common elements with previously transmitted configurations.

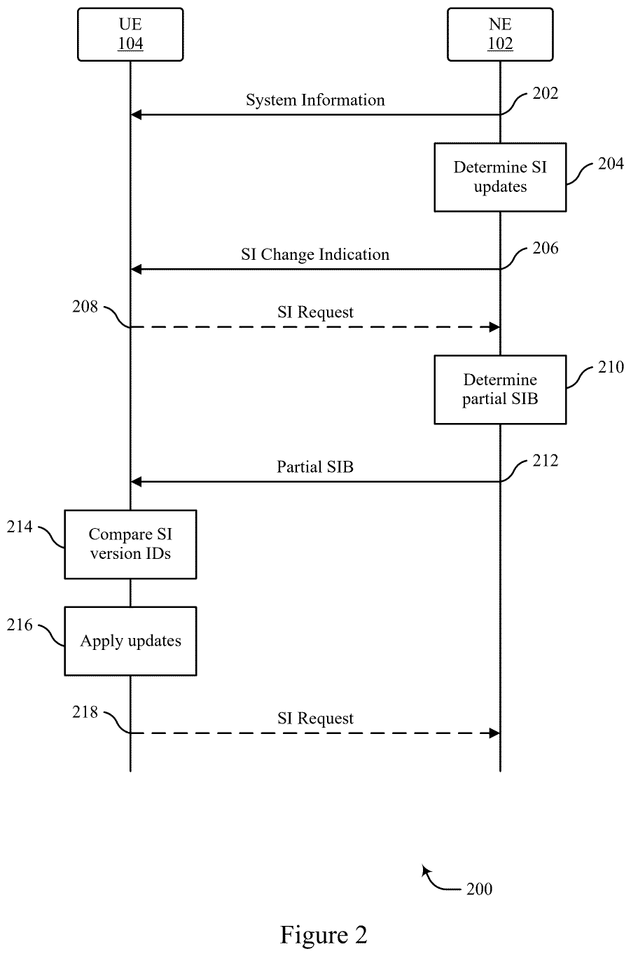

FIG. 2 illustrates an example signaling diagram 200 in accordance with aspects of the present disclosure. In some examples, the signaling diagram 200 may implement aspects of the wireless communications system 100. For example, the signaling diagram 200 illustrates communication between a UE 104 and an NE 102, which may include or be examples of the corresponding devices as described with reference to FIG. 1. Alternative examples of the following may be implemented, where some processes are performed in a different order than described or are not performed. In some cases, processes may include additional features not mentioned below, or further processes may be added.

At 202, the NE 102 transmits, and the UE 104 receives, SI for a cell served by the NE 102 in which the UE 104 is located. The SI may include, but is not limited to, a MIB and at least one SIB, such as a SIB1 or other SIB. The SIB includes a first version identifier (e.g., valueTag) of the SIB and a set of IEs. For example, the SIB may include a set of IEs including parameters Parameter_1, Parameter_2, Parameter_3, Parameter_4, and Parameter_5. Parameter_2 may further include two subparameters subParameter_1a and subParameter_1b. The UE 104 stores the at least one SIB. In some examples, the UE 104 is operating in an RRC idle or inactive mode.

At 204, the NE 102 may determine a change (e.g., modification, update) in one or more parameters of the SI. For example, the NE 102 may determine one or more modified values for a subset (e.g., one or more) IEs of the set of IEs included in the SIB. An IE may correspond to a parameter, a subparameter, or the like, among other examples.

At 206, the NE 102 may transmit, and the UE 104 may receive, an indication of the change in the SI. The indication may be included as part of a paging message (e.g., paging downlink control information (DCI), an RRC paging message, or as part of SI scheduling in SIB1). In some examples, the paging message may indicate the SIB associated with the modified subset of IEs. Additionally, or alternatively, the paging message may indicate a version identifier (e.g., newValueTag) associated with the modified version of the subset, e.g., with respect to the original version of the subset included in the SIB.

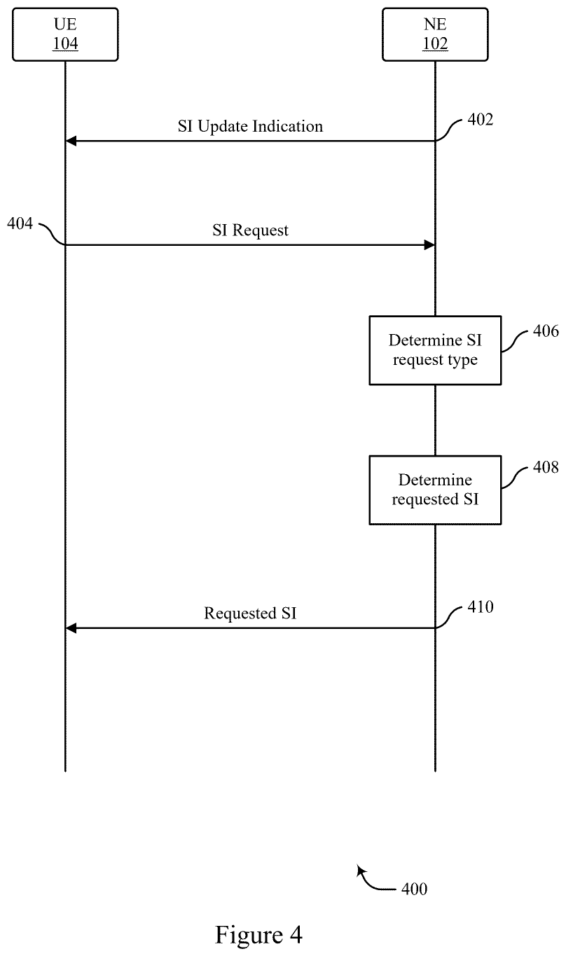

At 208, in some examples, the UE 104 may transmit, and the NE 102 may receive, an SI request. In some examples, such as described in greater detail with reference to FIG. 4, the SI request may indicate whether the UE 104 is requesting a partial SIB containing only updated parameters or a complete SIB containing all parameters. In the example illustrated by FIG. 2, the UE 104 may indicate a request for a partial SIB. In implementations, the UE 104 may transmit the SI request in response to receiving the indication of the change in the SI.

At 210, the NE 102 determines a partial SIB based on the change in the SI and, if applicable, the SI request received from the UE 104. For example, the NE 102 may determine the partial SIB by identifying a subset of IEs (e.g., parameters, subparameters) within the SIB that require updated values and obtaining a current version identifier associated with the SIB. The NE 102 may identify or otherwise select a partial SIB (e.g., a predefined partial SIB) corresponding to or otherwise including the subset of IEs. In implementations, the partial SIB is defined for (e.g., associated with, corresponds to) the SIB being updated. For instance, each SIB (e.g., SIB1, SIB2, and so forth) may be associated with a predefined partial SIB that contains a subset of the IEs included in the complete SIB. Each partial SIB utilizes the corresponding complete SIB's schema definition for encoding to ensure consistency and compatibility.

Each parameter/IE may correspond to an individual LeafUpdate in the partial SIB, and the partial SIB may include the subset of IEs as a list (e.g., sequence, set) updates-IE of LeafUpdates. Continuing the aforementioned example, the partial SIB may include updates for subParameter_1b, Parameter_3, and Parameter_5. Each LeafUpdate is a CHOICE structure that identifies the parameter being updated. For example, each CHOICE structure contains a parameter identifier (e.g., “subParameter-1b”), an optional need code (op), and the updated value for the corresponding IE. The partial SIB may further include a version identifier of the partial SIB (newValueTag) and a SIB identity (SIB-Identity) corresponding to (e.g., indicating, identifying) the original SIB. That is, the partial SIB and the original SIB may share the same SIB identity. SIB-Identity includes an indication of a SIB type of the SIB and a baseValueTag corresponding to the valueTag of the SIB. The partial SIB may include, for example: SIB-Identity{sibType, baseValueTag}, newValueTag, and updates-IE as a SEQUENCE OF LeafUpdate.

The NE 102 populates the partial SIB by setting the base version identifier baseValueTag of the partial SIB equal to the current version identifier of the SIB (e.g., to the value of valueTag indicated in the SIB at 202), assigning a new version identifier NewValueTag for the updated version of the SIB, and including updated values for the modified IEs. The NewValueTag indicates what the UE 104 should store after a successful merge. Additionally, the NE 102 may select a need code for one or more of the modified IEs. By including need codes in each CHOICE structure rather than codifying them in specifications, the NE 102 can dynamically select parameter handling behavior on a case-by-case basis. For example, when an IE of the partial SIB is not updated and the partial SIB therefore does not include an updated value for the IE, the NE 102 can select a need code that instructs the UE 104 to maintain the existing value of the IE, release the current value, or set a default value.

An ASN.1 example of this implementation is as follows.

Identify the target SIB instance and its baseline (valueTag):

SIB-Identity ::= SEQUENCE {

| | |
|---|---|
| sibType | ENUMERATED { |

sib1(0), sib2(1), sib3(2), sib4(3), sib5(4), sib6(5), sib7(6), sib8(7),
sib9(8), sib10(9), posSIB1(20), posSIB2(21), ... },

| | |
|---|---|
| sibInstance | INTEGER (0..3) OPTIONAL, -- for specific |
| | SI-area code if needed |
| baseValueTag | INTEGER (0..65535) -- tag the UE has cached |

```
  }
  New tag that will label the post-merge result:
  NewValueTag ::= INTEGER (0..65535)
    Operation semantics for non-scalar fields:
  DeltaOp ::= ENUMERATED { replace(0), maintain(1), release(2),
specific behavior(3), ... }
```

A generic leaf update uses an explicit CHOICE to be self-describing.

Each alternative names a known leaf type from the original SIB's schema.

| LeafUpdate ::= CHOICE { | |
|---|---|
| -- Example alternatives; in practice, one alternative per | |
| “addressable leaf” | |
| subParameter-1b | SEQUENCE { |
| op | DeltaOp DEFAULT replace, |
| value | SubParameter-1bType |
| }, | |
| parameter-3 | SEQUENCE { |
| op | DeltaOp DEFAULT replace, |
| value | Parameter-3Type |
| }, | |
| parameter-5 | SEQUENCE { |
| op | DeltaOp DEFAULT replace, |
| value | Parameter-5Type |

```
  },
  ... -- extensibility marker for future leaves
}
```

In some examples, the NE 102 may optionally bundle multiple IE updates within a single partial SIB transmission:

SIB-Delta ::= SEQUENCE {

| target | SIB-Identity, | |
|---|---|---|
| newValueTag | NewValueTag, | |
| updates | SEQUENCE (SIZE(1..maxUpdates)) OF | |
| | LeafUpdate, | |
| validity | SEQUENCE { | |
| | duration | INTEGER (0..86400) |
| | | OPTIONAL, -- seconds |
| | siAreaScope | INTEGER (0..1023) |
| | | OPTIONAL |

} OPTIONAL,

...
}

maxUpdates INTEGER::=32 (some maximum value—beyond this gNB may update/transmit the entire SIB)

The validity field in the above example provides temporal and spatial constraints for the partial SIB updates. For example, the duration parameter may specify a time period in seconds during which the partial SIB remains valid, after which the UE 104 may reacquire complete SI. This temporal validity mechanism enables the NE 102 to control how long delta updates remain applicable, particularly in scenarios where rapid SI changes may occur or where network conditions may affect the reliability of incremental updates. The siAreaScope parameter may define a geographical or logical area identifier within which the partial SIB updates apply, allowing the NE 102 to limit the scope of delta signaling to specific coverage areas or SI areas. In some cases, the siAreaScope may correspond to a SI area code that enables selective application of partial SIB updates across different regions of the network coverage, supporting scenarios where different areas may have different SI update requirements or where partial updates may only be relevant within specific geographical boundaries.

Additionally, or alternatively, the partial SIB may utilize a compact SIB-specific bitmask. Here, the partial SIB includes a bitmap (“DeltaMap”) where each bit corresponds to a respective IE of the associated complete SIB, arranged in a predetermined addressing order that matches the complete SIB's structure. The value of each bit in the bitmap indicates whether an updated value for the corresponding IE is included in the partial SIB payload (“DeltaPayloads”). The bitmap may be a positional BIT STRING structure. The payload structure includes only updated values arranged in the same predetermined order as the bitmap. This approach provides extremely compact encoding when using unaligned Packed Encoding Rules because the presence indication requires only a short bitmap and the payload order is predetermined, avoiding per-parameter CHOICE structure overhead while minimizing partial SIB size.

In this example, the NE 102 determines the addressing order for the set of IEs in the SIB, including child IEs within hierarchical structures, to establish the bitmap correspondence. The NE 102 sets bitmap bits to a first value (e.g., zero) for unchanged IEs and to a second value (e.g., one) for modified IEs that require updates. The NE 102 encodes the corresponding payload containing the updated values for the subset of IEs (e.g., as indicated by the bitmap), sets the new version identifier for the updated SIB version, and includes the SIB identity to enable proper association with the original SIB. This bitmap-based encoding approach supports future evolution through extension of the bitmap and addition of trailing payload fields without requiring structural changes to existing implementations.

An ASN.1 example of this implementation for a SIB “SIBx” is as follows.

| SIBx ::= SEQUENCE { | |
|---|---|
| parameter-1 | Param1Type OPTIONAL, |
| parameter-2 | SEQUENCE { |
| | sub-parameter-1a Sub1aType OPTIONAL, |
| | sub-parameter-1b Sub1bType OPTIONAL, |
| | ... |
| | } OPTIONAL, |
| parameter-3 | Param3Type OPTIONAL, |
| parameter-4 | Param4Type OPTIONAL, |
| parameter-5 | Param5Type OPTIONAL, |

...
}

Delta map: one bit per addressable leaf in depth-first order.

SIBx-DeltaMap::=BIT STRING (SIZE (6)) -bits: p1, p2.1a, p2.1b, p3, p4, p5

Delta payloads appear only for bits that are ‘1’, in the same fixed order.

SIBx-DeltaPayloads ::= SEQUENCE {

| | | |
|---|---|---|
| p1 Param1Type | BOOLEAN | OPTIONAL, -- present iff map[0]=1 |
| p2-1a Sub1aType | BOOLEAN | OPTIONAL, -- present iff map[1]=1 |
| p2-1b Sub1bType | BOOLEAN | OPTIONAL, -- present iff map[2]=1 |
| p3 Param3Type | BOOLEAN | OPTIONAL, -- present iff map[3]=1 |
| p4 Param4Type | BOOLEAN | OPTIONAL, -- present iff map[4]=1 |
| p5 Param5Type | BOOLEAN | OPTIONAL, -- present iff map[5]=1 |

```
  ...
}
  SIBx-Delta ::= SEQUENCE {
```

| | |
|---|---|
| target | SIB-Identity, -- sibType = (vendor-assigned “sibx” code) |

| | |
|---|---|
| newValueTag | NewValueTag, |

| | |
|---|---|
| map | SIBx-DeltaMap, |
| payloads | SIBx-DeltaPayloads, |
| op | DeltaOp DEFAULT replace, -- simple single-op policy |

...
}

As a specific example, to update only subParameter_1b, the NE 102 may set the bits in the bitmap equal to 001000 and encode only payloads.p2-1b equal to the corresponding new value. The above examples are useful since PER doesn't carry field names; the CHOICE structures or the fixed ordering combined with the bitmask provides self-description to send a “leaf” by itself. Versioning via baseValueTag and/or newValueTag prevents mismerges and gives paging a concise handle. For example, the paging message carrying the SI change indication at 206 may indicate the newValueTag associated with the partial SIB. These examples show how a single SIB (SIBx) can be updated, but the techniques described herein can also be used more generally such that the NE 102 can bundle several leaf updates in one partial SIB (atomic apply) across multiple SIBs.

At 212, the NE 102 transmits, and the UE 104 receives, the partial SIB. The NE 102 may transmit the partial SIB via broadcast (e.g., BCCH-DL-SCH), such as a non-critical extension alongside SystemInformation, or as dedicated SI delivery (e.g., when the UE 104 is in RRC connected mode). The NE 102 transmits the partial SIB in a delivery container corresponding to the transmit method (e.g., broadcast or dedicated delivery), as shown below:

BCCH-DL-SCH-MessageType ::= CHOICE {

| systemInformation | SystemInformation, | |
|---|---|---|
| sib-DeltaDelivery | SIB-Delta, | -- NEW broadcast |

```
wrapper (non-critical ext)
    ...
  }
  DedicatedSystemInformationDelivery-r19 ::= SEQUENCE {
```

| | |
|---|---|
| sib-Delta | SIB-Delta, |

```
    ...
  }
```

At 214, the UE 104 compares the version ID in the received partial SIB with the version ID of a stored SIB, such as the SIB1 received at 202. For example, the UE 104 may determine whether the baseValueTag included in the partial SIB matches the valueTag of the stored SIB.

At 216, if the UE 104 determines that the baseValueTag included in the partial SIB matches the valueTag of the stored SIB, the UE 104 may apply the updated values indicated in the partial SIB. For example, the UE 104 may merge the partial SIB with the stored SIB.

At 218, if the UE 104 determines that the baseValueTag included in the partial SIB does not match the valueTag of the stored SIB, the UE 104 may reacquire a complete SIB via broadcast SI acquisition. For example, the UE 104 may transmit, and the NE 102 may receive, an SI request indicating a request for the complete SIB.

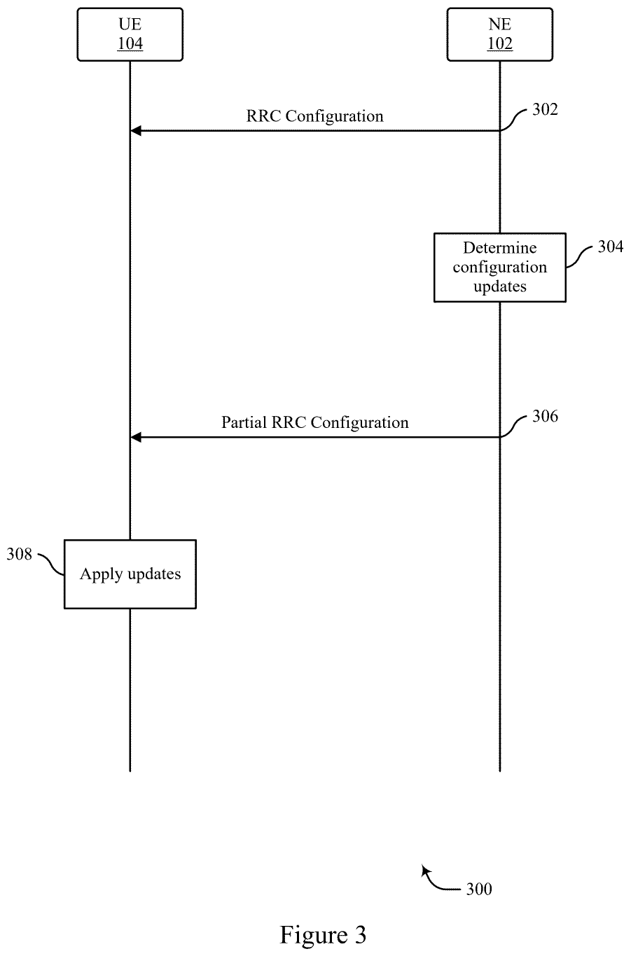

FIG. 3 illustrates an example signaling diagram 300 in accordance with aspects of the present disclosure. In some examples, the signaling diagram 300 may implement aspects of the wireless communications system 100. For example, the signaling diagram 300 illustrates communication between a UE 104 and an NE 102, which may include or be examples of the corresponding devices as described with reference to FIG. 1. The example signaling diagram 300 illustrates a generalized application of the delta signaling techniques described herein to RRC configuration management. Alternative examples of the following may be implemented, where some processes are performed in a different order than described or are not performed. In some cases, processes may include additional features not mentioned below, or further processes may be added.

At 302, the NE 102 transmits, and the UE 104 receives, an RRC configuration. The RRC configuration may include or be an example of any type of RRC configuration information such as radio bearer configurations, physical layer parameters, measurement configurations, mobility control information, security parameters, cell group configurations, or the like, among other examples. In some examples, the RRC configuration is associated with an identifier. For example, the NE 102 may assign an ID to the RRC configuration or the RRC configuration may be associated with a predefined identifier. In this manner, subsequent partial RRC configurations can reference specific stored configurations as baseline references. The UE 104 applies the RRC configuration upon reception.

At 304, the NE 102 may determine one or more updates to the RRC configuration. The updates may include or be an example of changes (e.g., modifications, updates) to one or more parameters of the RRC configuration.

At 306, the NE 102 transmits, and the UE 104 receives, a partial RRC configuration. The partial RRC configuration may include or be an example of a partial RRC configuration message defined as a separate RRC message type within the DL-DCCH-MessageType for dedicated signaling, within BCCH-DL-SCH-Message for broadcast applications, or within DL-CCCH-MessageType when applicable for specific use cases. This approach distinguishes delta configurations from regular RRC Reconfiguration messages, enabling the UE 104 to identify and process delta updates as described herein. The partial RRC configuration includes modified parameters for a previously-transmitted complete RRC configuration, such as an RRC configuration currently in use by the UE 104 (e.g., the RRC configuration transmitted at 302) or an RRC configuration no longer in use by the UE 104 (e.g., an RRC configuration transmitted prior to the currently-used RRC configuration). In the latter example, the previously-transmitted RRC configuration serves as a baseline configuration from which the modified parameters are determined.

The NE 102 addresses the partial RRC configuration to the corresponding complete RRC configuration. Additionally, the NE 102 may transmit the partial RRC configuration in the same RRC message as the corresponding complete RRC configuration or in a separate RRC message (e.g., subsequent to the complete RRC configuration). In the example of FIG. 3, the partial RRC configuration includes modified parameters for the complete RRC configuration transmitted at 302. Thus, the partial RRC configuration includes the same identifier as that of the complete RRC configuration and is transmitted in a separate RRC message. As another example, the partial RRC configuration may include parameters modified with respect to a baseline RRC configuration transmitted prior to 302. In this example, the NE 102 may transmit the baseline RRC configuration in the same message as the partial RRC configuration (e.g., both the baseline and the partial RRC configurations are transmitted together at 306). Alternatively, the NE 102 may transmit the baseline RRC configuration in a first RRC message and may transmit the partial RRC configuration in a subsequent, separate RRC message, where the first RRC message and the subsequent RRC message both indicate the identifier associated with the baseline RRC configuration.

In some examples, the NE 102 may determine a need code that applies to all IEs contained within the referenced complete RRC configuration. For example, when most parameter values are to be maintained from the baseline configuration, the NE 102 signals Need ‘M’ for IEs not explicitly included in the partial RRC configuration, instructing the UE 104 to preserve existing values. When most parameter values are to be released from the baseline configuration, the NE 102 signals Need ‘R’ for IEs not explicitly included in the partial RRC configuration, instructing the UE 104 to clear existing values. The need code signaled for each partial RRC configuration instance operates independently of need codes used in regular RRC configurations, providing flexibility in parameter handling behavior specific to delta operations.

In some examples, the NE 102 may generate delta configurations that include only essential parameters such as physical cell identity and cell index, while enabling the UE 104 to inherit remaining configuration parameters from the referenced baseline configuration. For instance, when generating a delta configuration, the NE 102 may select an appropriate baseline configuration identifier based on similarity to the updated configuration, minimizing the number of parameters that require explicit signaling in the delta update. This approach proves particularly effective when similar configurations exist across multiple cells, such as in handover candidate scenarios where the NE 102 defines multiple cells with overlapping parameter sets. The NE 102 can instruct the UE 104 to utilize a previously transmitted configuration as a baseline and apply only the specific parameter modifications included in the partial RRC configuration, rather than transmitting complete new RRC configurations. For example, when configuring handover candidates across multiple cells, the NE 102 may reference a specific configuration identifier from a previously configured cell and apply delta modifications to adapt the configuration for the target cell, significantly reducing signaling overhead while maintaining configuration accuracy. Additionally, or alternatively, the partial RRC configuration may indicate only a physical cell identity (PCI) and a cell index, and the remaining configuration parameters can be inherited from a previously-signaled PCI and cell index.

At 308, the UE 104 may apply the updates indicated in the partial RRC configuration received at 306. For example, if the partial RRC configuration includes the identifier associated with the RRC configuration received at 302, the UE 104 may merge the indicated updates with the stored RRC configuration. Alternatively, if the partial RRC configuration indicates an identifier associated with a baseline RRC configuration or is transmitted together with the baseline RRC configuration, the UE 104 may first apply the baseline RRC configuration and may then merge the indicated updates with the baseline RRC configuration.

FIG. 4 illustrates an example signaling diagram 400 in accordance with aspects of the present disclosure. In some examples, the signaling diagram 400 may implement aspects of the wireless communications system 100. For example, the signaling diagram 400 illustrates communications between a UE 104 and an NE 102, which may include or be examples of the corresponding devices as described with reference to FIG. 1. Alternative examples of the following may be implemented, where some processes are performed in a different order than described or are not performed. In some cases, processes may include additional features not mentioned below, or further processes may be added.

In the example of FIG. 4, the UE 104 may be operating in a cell served by the NE 102. The UE 104 may be camping (e.g., in an RRC idle or inactive mode) on the cell and may have previously acquired SI associated with the cell. Alternatively, the UE 104 may have recently arrived in the cell and thus may not have current SI for the cell. For instance, the UE 104 may be new to the cell or may have left the cell and returned, such that any previously-obtained SI is outdated. In cases where the UE 104 previously obtained and stored SI, such as a SIB, the UE 104 may have a stored version identifier (valueTag) associated with the stored SI.

At 402, the NE 102 may transmit, and the UE 104 may receive, an SI update indication. The SI update indication may include or be an example of a paging message (e.g., paging downlink control information (DCI), an RRC paging message, or as part of SI scheduling in SIB1). In some examples, the SI update indication includes a version identifier indicating the current SI version.

At 404, the UE 104 may transmit, and the NE 102 may receive, an SI request. The SI request may indicate whether the UE 104 requires a partial SIB containing only updated SI parameters or a complete SIB containing all SI parameters.

In a first example, the UE 104 may transmit the SI request via a random access channel message, such as RACH Message 3. The UE 104 may indicate whether a complete SIB or a partial SIB is requested by including a version identifier in the SI request. For example, for new UEs 104 entering the cell that have no stored SI, the SI request may include a dedicated version identifier, such as ‘0’, ‘F’, or another predetermined value, to indicate that the UE 104 is requesting a complete SIB rather than partial updates. Alternatively, if the UE 104 is requesting a partial SIB, the SI request may include a version identifier that indicates the version of the SIB currently stored by the UE 104.

Additionally, or alternatively, the SI request may include a bitmap where each bit corresponds to a respective SIB, enabling the UE 104 to specify which SIBs are being requested. For example, a first bit in the bitmap may correspond to MIB, a second bit may correspond to SIB1, and so forth. Additionally, or alternatively, the SI request may further include a request type flag that explicitly indicates whether the UE 104 is requesting a partial SIB or a complete SIB. The request type flag may include or be an example of a single bit, where a first value of the bit indicates request of a partial SIB and a second value of the bit indicates request of a complete SIB. In some examples, the request type flag is included with the bitmap, indicating whether the UE 104 is requesting partial or complete versions of the SIBs requested via the bitmap.

In a second example, the UE 104 may transmit the SI request using configured PRACH resources. The NE 102 may configure different PRACH resources (e.g., time-frequency resources, code domain resources, PRACH preambles, or a combination thereof) for different types of SI requests, such as a first set of PRACH resources dedicated for partial SIB requests and a second set of PRACH resources dedicated for complete SIB requests. Additionally, or alternatively, PRACH resources for SI requests may be preconfigured. Transmission of the SI request via the first set of PRACH resources may indicate that the UE 104 has a stored version of the SI being requested for the corresponding valueTag in the current or previous SI modification period, while the second set of PRACH resources may indicate that the UE 104 has no valid version of the SI being requested and therefore the complete SIB is being requested. The second set of PRACH resources may be utilized by UEs 104 new to the cell.

In some implementations, the NE 102 indicates the configured PRACH resources as part of paging DCI (e.g., as part of the SI update indication) or within MIB or SIB1. In some examples, the indication of the configured PRACH resources may include or be an example of a configuration index for PRACH resources designated for SI requests. The NE 102 may maintain the same PRACH resources for SI requests after SI modifications to simplify procedures for existing UEs 104 requesting updated SI. In some examples, basic SI such as MIB or SIB1 may not be broadcast by the NE 102 and may instead be delivered on-demand (e.g., in response to SI requests). In such examples, the PRACH resource configuration for SI requests may be provided by neighboring cells, ensuring that new UEs 104 can request necessary SI even when minimal broadcast information is available. In such cases, the new UE 104 detects the cell using primary and secondary synchronization signals before initiating SI requests.

At 406, in response to receiving the SI request from the UE 104, the NE 102 determines the type of SI request based on the PRACH resources or corresponding PRACH preamble used by the UE 104. This approach enables the NE 102 to immediately identify the type of response required without additional signaling overhead. For example, the NE 102 may determine that the UE 104 is requesting a complete SIB if the SI request includes the dedicated value tag and/or if the SI request is transmitted via the second set of PRACH resources. Alternatively, the NE 102 may determine that the UE 104 possesses SI for the requested SIB(s) up to the version identifier indicated in the SI request. As another example, based on the SI request being transmitted via the first set of PRACH resources, the NE 102 may determine that the UE 104 possesses SI for the requested SIB(s) up to the version identifier associated with the most recent SI update indication, such as that transmitted at 402.

At 408, the NE 102 identifies the IEs to be transmitted to the UE 104 based on the SI request type. For example, if the SI request indicated a version identifier, the NE 102 determines the IE values that have changed since the SIB was updated after the indicated version identifier. Alternatively, if the SI request indicated the dedicated value tag and/or was transmitted via the second set of PRACH resources, the NE 102 identifies the complete SIB(s) needed by the UE 104.

At 410, the NE 102 transmits, and the UE 104 receives, the requested SI, e.g., as a partial SIB or a complete SIB as appropriate. In some examples, the NE 102 provides the requested SI via downlink PDSCH transmission. Here, the NE 102 may indicate PDSCH resources in the paging DCI, utilizing scheduling mechanisms similar to SIB or SystemInformation message scheduling while transmitting only the updated information rather than complete SIBs.

In some scenarios, prior to transmitting the requested SI, the NE 102 may request that the UE 104 establish an RRC Connected state or utilize downlink small data transmission (SDT) functionality when the UE 104 is in an RRC inactive or idle state. This approach may be employed when the volume of updated information makes delivery inefficient using full beam sweeping procedures for an inactive or idle UE 104, enabling more targeted and efficient transmission of SI updates.

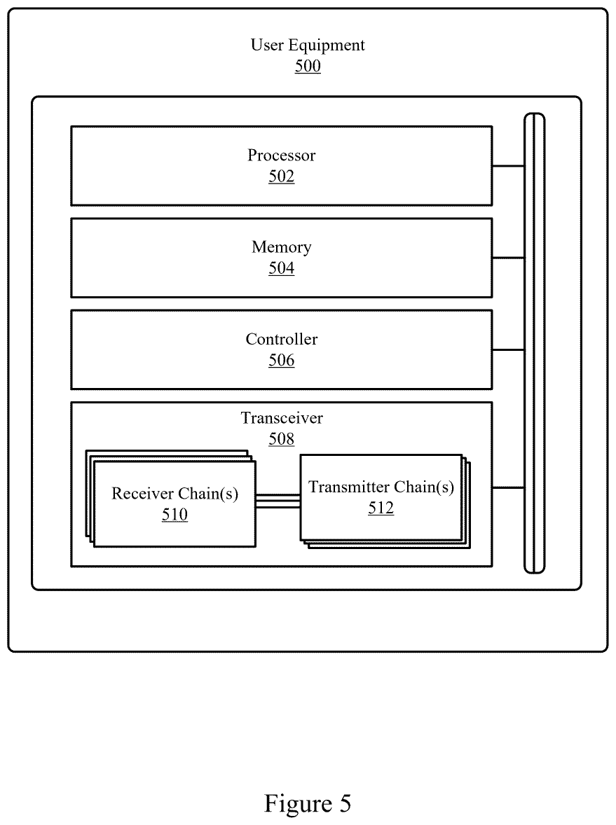

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a central processing unit (CPU), an ASIC, a field-programmable gate-array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to or operable to support a means for receiving and storing SI including a MIB and at least one SIB, where the at least one SIB includes a first version identifier and a set of IEs, receiving an indication of a change in the SI, and receiving a partial SIB, where the partial SIB includes a subset of IEs of the set of IEs, modified values for at least one IE of the subset of IEs, the first version identifier, and a second version identifier of the partial SIB, where the first version identifier is indicative of a reference version of the at least one SIB and the second version identifier is indicative of a modified version of the subset of IEs relative to the reference version. In this manner, the UE 500 reduces processing overhead and energy consumption by receiving only modified parameters rather than complete SI blocks, while maintaining synchronization with network SI updates.

Additionally, or alternatively, the UE 500 may be configured to support any one or combination of comparing a third version identifier with the first version identifier, where the third version identifier indicates a version of the at least one SIB stored by the UE, and one of: if the third version identifier matches the first version identifier, apply the modified values to update the at least one SIB and replace the first version identifier with the second version identifier, or if the third version identifier does not match the first version identifier, reacquire a complete SIB via broadcast SI acquisition. This aspect prevents application of incompatible delta updates that could result in corrupted SI states and ensures reliable SI synchronization between the UE 500 and network entities.

Additionally, or alternatively, the UE 500 may be configured to support any one or combination of transmitting a RACH message indicating an SI request, the SI request including at least one of a third version identifier, a request type flag, or a bitmap, each bit in the bitmap corresponding to a respective complete SIB. This aspect enables efficient signaling of SI requirements while minimizing signaling overhead by allowing selective SIB requests and explicit indication of partial versus complete SIB needs.

Additionally, or alternatively, the UE 500 may be configured to support any one or combination of transmitting an SI request via PRACH resources configured for partial SIB requests or PRACH resources configured for complete SIB requests. This aspect allows immediate identification of request type by network entities without additional signaling overhead, enabling faster response preparation and improved system efficiency.

Additionally, or alternatively, the UE 500 may be configured to support any one or combination of the partial SIB is encoded using ASN.1 with PER and includes a SIB identity that identifies the at least one SIB on which the partial SIB is based. This aspect ensures compatibility with existing encoding frameworks while enabling selective parameter transmission through proper SIB association and identification.

Additionally, or alternatively, the UE 500 may be configured to support any one or combination of each IE of the subset of IEs in the partial SIB is identified using a respective CHOICE structure including a corresponding need code field. This aspect provides self-describing parameter updates that enable individual information element transmission and processing without requiring complete SIB structures, overcoming limitations of positional encoding.

Additionally, or alternatively, the UE 500 may be configured to support any one or combination of each CHOICE structure identifying the at least one IE includes a respective modified value of the modified values. This aspect ensures that each parameter update contains both identification information and updated values in a single structure, enabling atomic parameter updates and preventing partial application errors.

Additionally, or alternatively, the UE 500 may be configured to support any one or combination of the partial SIB includes a bitmap indicating bit positions of the subset of IEs within the at least one SIB, each bit in the bitmap corresponding to a respective IE of the subset of IEs, and a value of each bit in the bitmap indicates whether a modified value for the respective IE is included in the partial SIB. This aspect provides extremely compact encoding for parameter updates by utilizing minimal bitmap overhead and predetermined parameter ordering, reducing transmission size and processing complexity.

Additionally, or alternatively, the UE 500 may support at least one memory (e.g., the memory 504) and at least one processor (e.g., the processor 502) coupled with the at least one memory and configured to cause the UE 500 to receive SI including a MIB and at least one SIB, where the at least one SIB includes a first version identifier of the SIB and a set of IEs, receive an indication of a change in the SI, and receive a partial SIB, where the partial SIB includes a subset of IEs of the set of IEs, modified values for at least one IE of the subset of IEs, the first version identifier, and a second version identifier of the partial SIB, where the first version identifier is indicative of a reference version of the at least one SIB and the second version identifier is indicative of a modified version of the subset of IEs relative to the reference version. In this manner, the UE 500 reduces processing overhead and energy consumption by receiving only modified parameters rather than complete SI blocks, while maintaining synchronization with network SI updates.

Additionally, or alternatively, the UE 500 may be configured to support any one or combination of the at least one processor is further operable to cause the UE 500 to compare a third version identifier with the first version identifier, where the third version identifier indicates a version of the at least one SIB stored by the UE, and one of: if the third version identifier matches the first version identifier, apply the modified values to update the at least one SIB and replace the first version identifier with the second version identifier, or if the third version identifier does not match the first version identifier, reacquire a complete SIB via broadcast SI acquisition. This aspect prevents application of incompatible delta updates that could result in corrupted SI states and ensures reliable SI synchronization between the UE 500 and network entities.

Additionally, or alternatively, the UE 500 may be configured to support any one or combination of the at least one processor is further operable to cause the UE 500 to transmit a RACH message indicating an SI request, the SI request including at least one of a third version identifier, a request type flag, or a bitmap, each bit in the bitmap corresponding to a respective complete SIB. This aspect enables efficient signaling of SI requirements while minimizing signaling overhead by allowing selective SIB requests and explicit indication of partial versus complete SIB needs.

Additionally, or alternatively, the UE 500 may be configured to support any one or combination of the at least one processor is further operable to cause the UE 500 to transmit an SI request via PRACH resources configured for partial SIB requests or PRACH resources configured for complete SIB requests. This aspect allows immediate identification of request type by network entities without additional signaling overhead, enabling faster response preparation and improved system efficiency.

Additionally, or alternatively, the UE 500 may be configured to support any one or combination of the partial SIB is encoded using ASN.1 with PER and includes a SIB identity that identifies the at least one SIB on which the partial SIB is based. This aspect ensures compatibility with existing encoding frameworks while enabling selective parameter transmission through proper SIB association and identification.

Additionally, or alternatively, the UE 500 may be configured to support any one or combination of each IE of the subset of IEs in the partial SIB is identified using a respective CHOICE structure including a corresponding need code field. This aspect provides self-describing parameter updates that enable individual information element transmission and processing without requiring complete SIB structures, overcoming limitations of positional encoding.

Additionally, or alternatively, the UE 500 may be configured to support any one or combination of each CHOICE structure identifying the at least one IE includes a respective modified value of the modified values. This aspect ensures that each parameter update contains both identification information and updated values in a single structure, enabling atomic parameter updates and preventing partial application errors.

Additionally, or alternatively, the UE 500 may be configured to support any one or combination of the partial SIB includes a bitmap indicating bit positions of the subset of IEs within the at least one SIB, each bit in the bitmap corresponding to a respective IE of the subset of IEs, and a value of each bit in the bitmap indicates whether a modified value for the respective IE is included in the partial SIB. This aspect provides extremely compact encoding for parameter updates by utilizing minimal bitmap overhead and predetermined parameter ordering, reducing transmission size and processing complexity.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

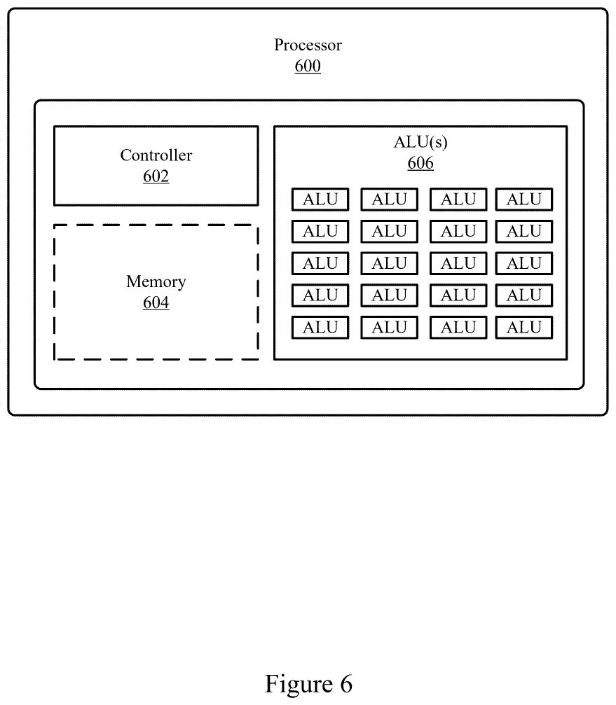

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory addresses of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, ALUs 606, and other functional units of the processor 600.

The memory 604 may include one or more caches (e.g., memory local to or included in the processor 600 or other memory, such as RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, and the controller 602, and may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 may be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support at least one controller (e.g., the controller 602) coupled with at least one memory (e.g., the memory 604) and configured to cause the processor to receive SI including a MIB and at least one SIB, where the at least one SIB includes a first version identifier of the SIB and a set of IEs, receive an indication of a change in the SI, and receive a partial SIB, where the partial SIB includes a subset of IEs of the set of IEs, modified values for at least one IE of the subset of IEs, the first version identifier, and a second version identifier of the partial SIB, where the first version identifier is indicative of a reference version of the at least one SIB and the second version identifier is indicative of a modified version of the subset of IEs relative to the reference version. In this manner, the processor 600 reduces processing overhead and energy consumption by receiving only modified parameters rather than complete SI blocks, while maintaining synchronization with network SI updates.

Additionally, or alternatively, the processor 600 may be configured to or operable to support any one or combination of compare a third version identifier with the first version identifier, where the third version identifier indicates a version of the at least one SIB stored by the UE, and one of: if the third version identifier matches the first version identifier, apply the modified values to update the at least one SIB and replace the first version identifier with the second version identifier, or if the third version identifier does not match the first version identifier, reacquire a complete SIB via broadcast SI acquisition. This aspect prevents application of incompatible delta updates that could result in corrupted SI states and ensures reliable SI synchronization between the UE and network entities.

Additionally, or alternatively, the processor 600 may be configured to or operable to support any one or combination of transmit a RACH message indicating an SI request, the SI request including at least one of a third version identifier, a request type flag, or a bitmap, each bit in the bitmap corresponding to a respective complete SIB. This aspect enables efficient signaling of SI requirements while minimizing signaling overhead by allowing selective SIB requests and explicit indication of partial versus complete SIB needs.

Additionally, or alternatively, the processor 600 may be configured to or operable to support any one or combination of transmit an SI request via PRACH resources configured for partial SIB requests or PRACH resources configured for complete SIB requests. This aspect allows immediate identification of request type by network entities without additional signaling overhead, enabling faster response preparation and improved system efficiency.

Additionally, or alternatively, the processor 600 may be configured to or operable to support any one or combination of the partial SIB is encoded using ASN.1 with PER and includes a SIB identity that identifies the at least one SIB on which the partial SIB is based. This aspect ensures compatibility with existing encoding frameworks while enabling selective parameter transmission through proper SIB association and identification.

Additionally, or alternatively, the processor 600 may be configured to or operable to support any one or combination of each IE of the subset of IEs in the partial SIB is identified using a respective CHOICE structure including a corresponding need code field. This aspect provides self-describing parameter updates that enable individual information element transmission and processing without requiring complete SIB structures, overcoming limitations of positional encoding.

Additionally, or alternatively, the processor 600 may be configured to or operable to support any one or combination of each CHOICE structure identifying the at least one IE includes a respective modified value of the modified values. This aspect ensures that each parameter update contains both identification information and updated values in a single structure, enabling atomic parameter updates and preventing partial application errors.

Additionally, or alternatively, the processor 600 may be configured to or operable to support any one or combination of the partial SIB includes a bitmap indicating bit positions of the subset of IEs within the at least one SIB, each bit in the bitmap corresponding to a respective IE of the subset of IEs, and a value of each bit in the bitmap indicates whether a modified value for the respective IE is included in the partial SIB. This aspect provides extremely compact encoding for parameter updates by utilizing minimal bitmap overhead and predetermined parameter ordering, reducing transmission size and processing complexity.

Additionally, or alternatively, or alternatively, the processor 600 may be configured to or operable to support at least one controller (e.g., the controller 602) coupled with at least one memory (e.g., the memory 604) and configured to cause the processor to transmit SI including a MIB and at least one SIB, where the at least one SIB includes a first version identifier of the SIB and a set of IEs, transmit an indication of a change in the SI based on modified values for a subset of IEs of the set of IEs, and transmit a partial SIB associated with the subset of IEs, where the partial SIB includes the subset of IEs, the modified values, the first version identifier, and a second version identifier of the partial SIB, where the first version identifier is indicative of a reference version of the at least one SIB and the second version identifier is indicative of a modified version of the subset of IEs relative to the reference version. In this manner, the processor 600 reduces network energy consumption and signaling overhead by transmitting only modified parameters while ensuring reliable SI delivery and UE synchronization.

Additionally, or alternatively, the processor 600 may be configured to or operable to support any one or combination of receive an SI request from a UE, where the SI request includes a third version identifier. This aspect enables the processor 600 to determine the specific SI updates required by each UE based on their stored SI versions, allowing targeted and efficient delta signaling.

Additionally, or alternatively, the processor 600 may be configured to or operable to support any one or combination of the SI request is received via a random access channel message, where the processor 600 is further operable to determine whether the SI request is for the partial SIB or for a complete SIB based on the third version identifier, a request type flag included in the SI request, or a bitmap included in the SI request, where each bit in the bitmap corresponds to a respective complete SIB. This aspect enables automatic differentiation between UEs requiring complete SI and those needing only updates, optimizing resource allocation and transmission efficiency.

Additionally, or alternatively, the processor 600 may be configured to or operable to support any one or combination of the third version identifier indicates a version of the at least one SIB stored by the UE, where the modified values are determined based on the third version identifier. This aspect ensures that only the necessary parameter changes are transmitted to each UE, minimizing signaling overhead while maintaining SI accuracy and consistency.

Additionally, or alternatively, the processor 600 may be configured to or operable to support any one or combination of the SI request is received via PRACH resources configured for partial SIB requests or PRACH resources configured for complete SIB requests, where the processor 600 is further operable to determine whether the SI request is for the partial SIB or for a complete SIB based on the PRACH resources or a corresponding PRACH preamble. This aspect enables immediate identification of request type without additional signaling overhead, allowing faster response preparation and improved system efficiency.

Additionally, or alternatively, the processor 600 may be configured to or operable to support any one or combination of the partial SIB is encoded using ASN.1 with PER and includes a SIB identity that identifies the at least one SIB on which the partial SIB is based. This aspect ensures compatibility with existing encoding frameworks while enabling selective parameter transmission through proper SIB association and identification.

Additionally, or alternatively, the processor 600 may be configured to or operable to support any one or combination of each IE of the subset of IEs in the partial SIB is identified using a respective CHOICE structure including a corresponding need code field. This aspect provides self-describing parameter updates that enable individual information element transmission and processing without requiring complete SIB structures, overcoming limitations of positional encoding.

Additionally, or alternatively, the processor 600 may be configured to or operable to support any one or combination of each CHOICE structure identifying the at least one IE includes a respective modified value of the modified values. This aspect ensures that each parameter update contains both identification information and updated values in a single structure, enabling atomic parameter updates and preventing partial application errors.

Additionally, or alternatively, the processor 600 may be configured to or operable to support any one or combination of the partial SIB includes a bitmap indicating bit positions of the subset of IEs within the at least one SIB, each bit in the bitmap corresponding to a respective IE of the subset of IEs, and a value of each bit in the bitmap indicates whether a modified value for the respective IE is included in the partial SIB. This aspect provides extremely compact encoding for parameter updates by utilizing minimal bitmap overhead and predetermined parameter ordering, reducing transmission size and processing complexity.

Additionally, or alternatively, the processor 600 may be configured to or operable to support any one or combination of the partial SIB is transmitted via a broadcast control channel or as dedicated SI delivery. This aspect enables flexible delivery mechanisms that can accommodate both broadcast scenarios for multiple UEs and targeted delivery for specific UEs, optimizing network resource utilization and transmission efficiency.

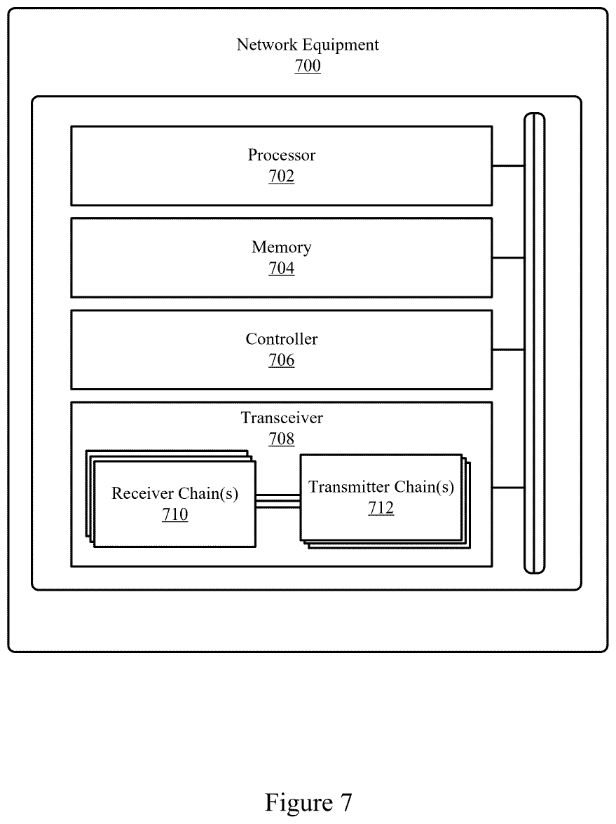

FIG. 7 illustrates an example of an NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to or operable to support a means for transmitting SI including a MIB and at least one SIB, where the at least one SIB includes a first version identifier of the SIB and a set of IEs, transmitting an indication of a change in the SI based on modified values for a subset of IEs of the set of IEs, and transmitting a partial SIB associated with the subset of IEs, where the partial SIB includes the subset of IEs, the modified values, the first version identifier, and a second version identifier of the partial SIB, where the first version identifier is indicative of a reference version of the at least one SIB and the second version identifier is indicative of a modified version of the subset of IEs relative to the reference version. In this manner, the NE 700 reduces network energy consumption and signaling overhead by transmitting only modified parameters while ensuring reliable SI delivery and UE synchronization.

Additionally, or alternatively, the NE 700 may be configured to support any one or combination of receiving an SI request from a UE, where the SI request includes a third version identifier. This aspect enables the NE 700 to determine the specific SI updates required by each UE based on their stored SI versions, allowing targeted and efficient delta signaling.

Additionally, or alternatively, the NE 700 may be configured to support any one or combination of the SI request is received via a random access channel message, the method further comprising determining whether the SI request is for the partial SIB or for a complete SIB based on the third version identifier, a request type flag included in the SI request, or a bitmap included in the SI request, where each bit in the bitmap corresponds to a respective complete SIB. This aspect enables automatic differentiation between UEs requiring complete SI and those needing only updates, optimizing resource allocation and transmission efficiency.

Additionally, or alternatively, the NE 700 may be configured to support any one or combination of the third version identifier indicates a version of the at least one SIB stored by the UE, where the modified values are determined based on the third version identifier. This aspect ensures that only the necessary parameter changes are transmitted to each UE, minimizing signaling overhead while maintaining SI accuracy and consistency.

Additionally, or alternatively, the NE 700 may be configured to support any one or combination of the SI request is received via PRACH resources configured for partial SIB requests or PRACH resources configured for complete SIB requests, the method further comprising determining whether the SI request is for the partial SIB or for a complete SIB based on the PRACH resources or a corresponding PRACH preamble. This aspect enables immediate identification of request type without additional signaling overhead, allowing faster response preparation and improved system efficiency.

Additionally, or alternatively, the NE 700 may be configured to support any one or combination of the partial SIB is encoded using ASN.1 with PER and includes a SIB identity that identifies the at least one SIB on which the partial SIB is based. This aspect ensures compatibility with existing encoding frameworks while enabling selective parameter transmission through proper SIB association and identification.

Additionally, or alternatively, the NE 700 may be configured to support any one or combination of each IE of the subset of IEs in the partial SIB is identified using a respective CHOICE structure including a corresponding need code field. This aspect provides self-describing parameter updates that enable individual information element transmission and processing without requiring complete SIB structures, overcoming limitations of positional encoding.

Additionally, or alternatively, the NE 700 may be configured to support any one or combination of each CHOICE structure identifying the at least one IE includes a respective modified value of the modified values. This aspect ensures that each parameter update contains both identification information and updated values in a single structure, enabling atomic parameter updates and preventing partial application errors.

Additionally, or alternatively, the NE 700 may be configured to support any one or combination of the partial SIB includes a bitmap indicating bit positions of the subset of IEs within the at least one SIB, each bit in the bitmap corresponding to a respective IE of the subset of IEs, and a value of each bit in the bitmap indicates whether a modified value for the respective IE is included in the partial SIB. This aspect provides extremely compact encoding for parameter updates by utilizing minimal bitmap overhead and predetermined parameter ordering, reducing transmission size and processing complexity.

Additionally, or alternatively, the NE 700 may be configured to support any one or combination of the partial SIB is transmitted via a broadcast control channel or as dedicated SI delivery. This aspect enables flexible delivery mechanisms that can accommodate both broadcast scenarios for multiple UEs and targeted delivery for specific UEs, optimizing network resource utilization and transmission efficiency.

Additionally, or alternatively, the NE 700 may support at least one memory (e.g., the memory 704) and at least one processor (e.g., the processor 702) coupled with the at least one memory and configured to cause the NE 700 to transmit SI including a MIB and at least one SIB, where the at least one SIB includes a first version identifier of the SIB and a set of IEs, transmit an indication of a change in the SI based on modified values for a subset of IEs of the set of IEs, and transmit a partial SIB associated with the subset of IEs, where the partial SIB includes the subset of IEs, the modified values, the first version identifier, and a second version identifier of the partial SIB, where the first version identifier is indicative of a reference version of the at least one SIB and the second version identifier is indicative of a modified version of the subset of IEs relative to the reference version. In this manner, the NE 700 reduces network energy consumption and signaling overhead by transmitting only modified parameters while ensuring reliable SI delivery and UE synchronization.

Additionally, or alternatively, the NE 700 may be configured to support any one or combination of the at least one processor is further operable to cause the NE to receive an SI request from a UE, where the SI request includes a third version identifier. This aspect enables the NE 700 to determine the specific SI updates required by each UE based on their stored SI versions, allowing targeted and efficient delta signaling.

Additionally, or alternatively, the NE 700 may be configured to support any one or combination of the SI request is received via a random access channel message, where the at least one processor is further operable to cause the NE to determine whether the SI request is for the partial SIB or for a complete SIB based on the third version identifier, a request type flag included in the SI request, or a bitmap included in the SI request, where each bit in the bitmap corresponds to a respective complete SIB. This aspect enables automatic differentiation between UEs requiring complete SI and those needing only updates, optimizing resource allocation and transmission efficiency.

Additionally, or alternatively, the NE 700 may be configured to support any one or combination of the third version identifier indicates a version of the at least one SIB stored by the UE, where the modified values are determined based on the third version identifier. This aspect ensures that only the necessary parameter changes are transmitted to each UE, minimizing signaling overhead while maintaining SI accuracy and consistency.

Additionally, or alternatively, the NE 700 may be configured to support any one or combination of the SI request is received via PRACH resources configured for partial SIB requests or PRACH resources configured for complete SIB requests, where the at least one processor is further operable to cause the NE to determine whether the SI request is for the partial SIB or for a complete SIB based on the PRACH resources or a corresponding PRACH preamble. This aspect enables immediate identification of request type without additional signaling overhead, allowing faster response preparation and improved system efficiency.

Additionally, or alternatively, the NE 700 may be configured to support any one or combination of the partial SIB is encoded using ASN.1 with PER and includes a SIB identity that identifies the at least one SIB on which the partial SIB is based. This aspect ensures compatibility with existing encoding frameworks while enabling selective parameter transmission through proper SIB association and identification.

Additionally, or alternatively, the NE 700 may be configured to support any one or combination of each IE of the subset of IEs in the partial SIB is identified using a respective CHOICE structure including a corresponding need code field. This aspect provides self-describing parameter updates that enable individual information element transmission and processing without requiring complete SIB structures, overcoming limitations of positional encoding.

Additionally, or alternatively, the NE 700 may be configured to support any one or combination of each CHOICE structure identifying the at least one IE includes a respective modified value of the modified values. This aspect ensures that each parameter update contains both identification information and updated values in a single structure, enabling atomic parameter updates and preventing partial application errors.

Additionally, or alternatively, the NE 700 may be configured to support any one or combination of the partial SIB includes a bitmap indicating bit positions of the subset of IEs within the at least one SIB, each bit in the bitmap corresponding to a respective IE of the subset of IEs, and a value of each bit in the bitmap indicates whether a modified value for the respective IE is included in the partial SIB. This aspect provides extremely compact encoding for parameter updates by utilizing minimal bitmap overhead and predetermined parameter ordering, reducing transmission size and processing complexity.

Additionally, or alternatively, the NE 700 may be configured to support any one or combination of the partial SIB is transmitted via a broadcast control channel or as dedicated SI delivery. This aspect enables flexible delivery mechanisms that can accommodate both broadcast scenarios for multiple UEs and targeted delivery for specific UEs, optimizing network resource utilization and transmission efficiency.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., an LNA) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

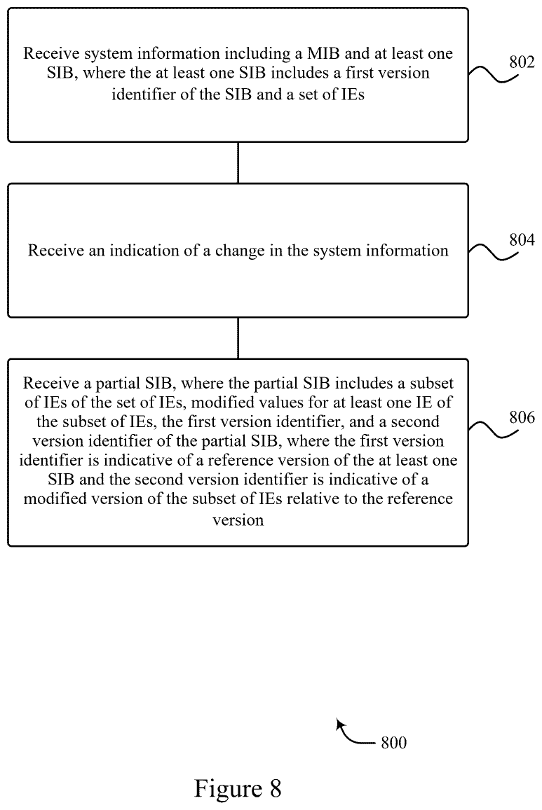

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 802, the method may include receiving system information including a MIB and at least one SIB, where the at least one SIB includes a first version identifier and a set of IEs. The operations of 802 may be performed in accordance with examples as described herein. In some implementations, aspects of the operations of 802 may be performed by a UE as described with reference to FIG. 5.

At 804, the method may include receiving an indication of a change in the system information. The operations of 804 may be performed in accordance with examples as described herein. In some implementations, aspects of the operations of 804 may be performed by a UE as described with reference to FIG. 5.

At 806, the method may include receiving a partial SIB, where the partial SIB includes a subset of IEs of the set of IEs, modified values for at least one IE of the subset of IEs, the first version identifier, and a second version identifier of the partial SIB, where the first version identifier is indicative of a reference version of the at least one SIB and the second version identifier is indicative of a modified version of the subset of IEs relative to the reference version. The operations of 806 may be performed in accordance with examples as described herein. In some implementations, aspects of the operations of 806 may be performed a UE as described with reference to FIG. 5.

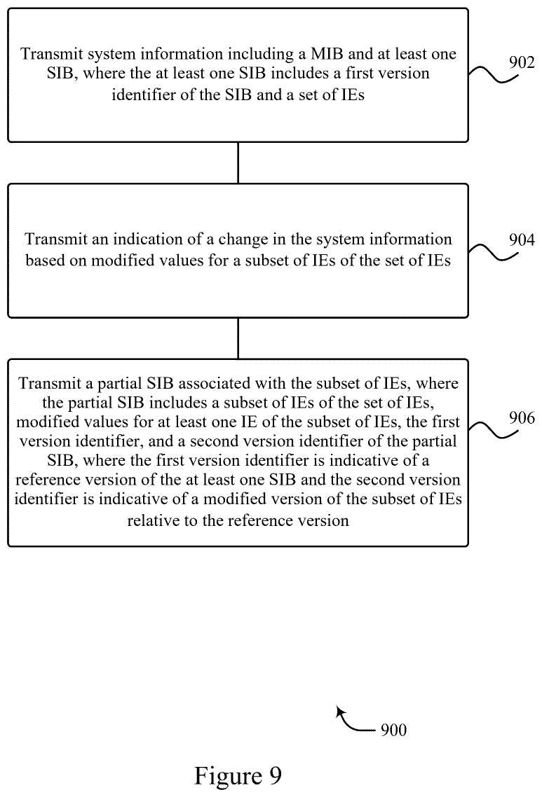

FIG. 9 illustrates a flowchart of a method 900 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 902, the method may include transmitting system information including a MIB and at least one SIB, where the at least one SIB includes a first version identifier of the SIB and a set of IEs. The operations of 902 may be performed in accordance with examples as described herein. In some implementations, aspects of the operations of 902 may be performed by an NE as described with reference to FIG. 7.

At 904, the method may include transmitting an indication of a change in the system information based at least in part on modified values for at least one IE of a subset of IEs of the set of IEs. The operations of 904 may be performed in accordance with examples as described herein. In some implementations, aspects of the operations of 904 may be performed by an NE as described with reference to FIG. 7.

At 906, the method may include transmitting a partial SIB associated with the subset of IEs, where the partial SIB includes the subset of IEs, the modified values, the first version identifier, and a second version identifier of the partial SIB, where the first version identifier is indicative of a reference version of the at least one SIB and the second version identifier is indicative of a modified version of the subset of IEs relative to the reference version. The operations of 906 may be performed in accordance with examples as described herein. In some implementations, aspects of the operations of 906 may be performed an NE as described with reference to FIG. 7.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity (NE) for wireless communication, comprising:
at least one memory; and
at least one processor coupled with the at least one memory and operable to cause the NE to:
transmit system information including a master information block (MIB) and at least one system information block (SIB), wherein the at least one SIB includes a first version identifier of the SIB and a set of information elements (IEs);
transmit an indication of a change in the system information based at least in part on modified values for at least one IE of a subset of IEs of the set of IEs; and
transmit a partial SIB associated with the subset of IEs, wherein the partial SIB includes the subset of IEs, the modified values, the first version identifier, and a second version identifier of the partial SIB, wherein the first version identifier is indicative of a reference version of the at least one SIB and the second version identifier is indicative of a modified version of the subset of IEs relative to the reference version.

2. The NE of claim 1, wherein the at least one processor is further operable to cause the NE to receive a system information request from a user equipment (UE), and wherein the system information request includes a third version identifier.

3. The NE of claim 2, wherein the system information request is received via a random access channel (RACH) message, and wherein the at least one processor is further operable to cause the NE to determine whether the system information request is for the partial SIB or for a complete SIB based at least in part on the third version identifier, a request type flag included in the system information request, or a bitmap included in the system information request, wherein each bit in the bitmap corresponds to a respective complete SIB.

4. The NE of claim 3, wherein the third version identifier indicates a version of the at least one SIB stored by the UE, and wherein the modified values are determined based at least in part on the third version identifier.

5. The NE of claim 2, wherein the system information request is received via physical random access channel (PRACH) resources configured for partial SIB requests or PRACH resources configured for complete SIB requests, and wherein the at least one processor is further operable to cause the NE to determine whether the system information request is for the partial SIB or for a complete SIB based at least in part on the PRACH resources or a corresponding PRACH preamble.

6. The NE of claim 1, wherein the partial SIB is encoded using Abstract Syntax Notation One (ASN.1) with packed encoding rules (PER) and includes a SIB identity that identifies the at least one SIB on which the partial SIB is based.

7. The NE of claim 6, wherein each IE of the subset of IEs in the partial SIB is identified using a respective CHOICE structure including a corresponding need code field.

8. The NE of claim 7, wherein each CHOICE structure identifying the at least one IE includes a respective modified value of the modified values.

9. The NE of claim 7, wherein:
the partial SIB includes a bitmap indicating bit positions of the subset of IEs within the at least one SIB, each bit in the bitmap corresponding to a respective IE of the subset of IEs, and
a value of each bit in the bitmap indicates whether a modified value for the respective IE is included in the partial SIB.

10. The NE of claim 1, wherein the partial SIB is transmitted via a broadcast control channel or as dedicated system information delivery.

11. A user equipment (UE) for wireless communication, comprising:
at least one memory; and
at least one processor coupled with the at least one memory and operable to cause the UE to:
receive system information including a master information block (MIB) and at least one system information block (SIB), wherein the at least one SIB includes a first version identifier of the SIB and a set of information elements (IEs);
receive an indication of a change in the system information; and
receive a partial SIB, wherein the partial SIB includes a subset of IEs of the set of IEs, modified values for at least one IE of the subset of IEs, the first version identifier, and a second version identifier of the partial SIB, wherein the first version identifier is indicative of a reference version of the at least one SIB and the second version identifier is indicative of a modified version of the subset of IEs relative to the reference version.

12. The UE of claim 11, wherein the at least one processor is further operable to cause the UE to:
compare a third version identifier with the first version identifier, wherein the third version identifier indicates a version of the at least one SIB stored by the UE; and one of:
if the third version identifier matches the first version identifier, apply the modified values to update the at least one SIB and replace the first version identifier with the second version identifier; or
if the third version identifier does not match the first version identifier, reacquire a complete SIB via broadcast system information acquisition.

13. The UE of claim 11, wherein the at least one processor is further operable to cause the UE to transmit a random access channel (RACH) message indicating a system information request, the system information request including at least one of a third version identifier, a request type flag, or a bitmap, each bit in the bitmap corresponding to a respective complete SIB.

14. The UE of claim 11, wherein the at least one processor is further operable to cause the UE to transmit a system information request via physical random access channel (PRACH) resources configured for partial SIB requests or PRACH resources configured for complete SIB requests.

15. The UE of claim 11, wherein the partial SIB is encoded using Abstract Syntax Notation One (ASN.1) with packed encoding rules (PER) and includes a SIB identity that identifies the at least one SIB on which the partial SIB is based.

16. The UE of claim 15, wherein each IE of the subset of IEs in the partial SIB is identified using a respective CHOICE structure including a corresponding need code field.

17. The UE of claim 16, wherein each CHOICE structure identifying the at least one IE includes a respective modified value of the modified values.

18. The UE of claim 16, wherein:
the partial SIB includes a bitmap indicating bit positions of the subset of IEs within the at least one SIB, each bit in the bitmap corresponding to a respective IE of the subset of IEs, and
a value of each bit in the bitmap indicates whether a modified value for the respective IE is included in the partial SIB.

19. A method performed by a network entity (NE), the method comprising:
transmitting system information including a master information block (MIB) and at least one system information block (SIB), wherein the at least one SIB includes a first version identifier of the SIB and a set of information elements (IEs);
transmitting an indication of a change in the system information based at least in part on modified values for at least one IE of a subset of IEs of the set of IEs; and
transmitting a partial SIB associated with the subset of IEs, wherein the partial SIB includes the subset of IEs, the modified values, the first version identifier, and a second version identifier of the partial SIB, wherein the first version identifier is indicative of a reference version of the at least one SIB and the second version identifier is indicative of a modified version of the subset of IEs relative to the reference version.

20. A method performed by a user equipment (UE), the method comprising:
receiving and storing system information including a master information block (MIB) and at least one system information block (SIB), wherein the at least one SIB includes a first version identifier and a set of information elements (IEs);
receiving an indication of a change in the system information; and
receiving a partial SIB, wherein the partial SIB includes a subset of IEs of the set of IEs, modified values for at least one IE of the subset of IEs, the first version identifier, and a second version identifier of the partial SIB, wherein the first version identifier is indicative of a reference version of the at least one SIB and the second version identifier is indicative of a modified version of the subset of IEs relative to the reference version.
